(19) United States
(12) Patent Application Publication
(10) Pub. No.: US 2017/0361135 A1
(43) Pub. Date: Dec. 21, 2017

(54) MID-TRUSS ANCHOR CLAMP

(71) Applicant: Lawrence A. Crookston, Barberton, OH (US)

(72) Inventor: Lawrence A. Crookston, Barberton, OH (US)

(21) Appl. No.: 15/627,581

(22) Filed: Jun. 20, 2017

Related U.S. Application Data
(60) Provisional application No. 62/352,150, filed on Jun. 20, 2016.

(51) Int. Cl. A62B 35/00; E04G 21/32

(52) U.S. Cl. CPC A62B 35/0068; E04G 21/3214; E04G 21/3276

(57) ABSTRACT

A roof truss anchor clamp for use with a worker's safety harness, a safety system incorporating the anchor clamp and a method of using the same. The anchor clamp includes a middle wall positionable adjacent an upper surface of a section of a roof truss rafter; a first side wall extending outwardly from one end of the middle wall; a second side wall extending outwardly from an opposite end of the middle wall; wherein a space is defined between the first and second side walls and the section of the rafter is receivable in the space. A fastener assembly is provided on the anchor clamp for securing the clamp to the rafter. A connector is also engaged with the anchor clamp for securing a worker's safety harness thereto.

### CROSS REFERENCE TO RELATED APPLICATIONS

This application claims the benefit of U.S. Provisional Patent Application Ser. No. 62/352,150 filed Jun. 20, 2016, the entire disclosure of which is incorporated herein by reference.

### BACKGROUND OF THE INVENTION

### Technical Field

The present disclosure is generally related to building products. More particularly, the present disclosure is directed to products used during construction of a roof. Specifically, the disclosure relates to an anchor clamp for a safety anchoring system used to aid in arresting falls. The anchor clamp comprises a generally U-shaped member that is selectively engageable with a roof truss rafter at a position between an apex and a wall-frame end of the truss. A worker's safety harness is selectively engageable with the U-shaped member. The anchor clamp remains secured to the rafter and be readily locatable and usable during subsequent construction procedures performed on the roof such as carpentry and during installation of HVAC vents, plumbing vents, and rain ware.

### Background Information

Roofers, workers and tradesmen may be required to spend a considerable amount of time on structures located a distance vertically above a ground surface such as a roof. One of the problems that such workers face is the potential for falling off a partially constructed or fully constructed roof. In order to address this issue, a variety of differently shaped and configured safety harnesses and roof anchors have been suggested in the prior art. In most of these systems, the worker wears a harness and utilizes a carabiner or D-clamp at an end of a lanyard secured to the harness to tie himself or herself off to a safety anchor on the roof. It is important that such roof anchors be relatively quickly and easily installed or the worker may decide that he or she is too busy to secure an anchor so that they can then tie off. If a safety anchor is not utilized, the worker is potentially in danger from falling off the roof and there is a potential liability issue for the owner of the building and/or for the company that employs the worker.

### SUMMARY

The device disclosed herein is a mid-truss anchor clamp that is capable of being quickly and easily installed on an already-erected roof truss. This anchor clamp is suitable for use as a quick connection point for a safety anchor.

A roof truss anchor clamp for use with a worker's safety harness, a safety system incorporating the anchor clamp and a method of using the same is disclosed herein. The anchor clamp may include a middle wall; a first side wall extending outwardly from one end of the middle wall; and a second side wall extending outwardly from an opposite end of the middle wall. The middle wall is positionalbe adjacent an upper surface of a section of a roof truss rafter. A space is defined in the anchor clamp between the first and second side walls and the section of the rafter is receivable in this space. A fastener assembly is provided on the anchor clamp for securing the clamp to the rafter. A connector is also provided on the anchor clamp for securing a worker's safety harness thereto.

In one aspect, the disclosure may provide a roof truss anchor clamp for use with a worker's safety harness; said anchor clamp comprising a first side wall adapted to be positioned adjacent a first side surface of a roof rafter; a fastener assembly that is adapted to secure the anchor clamp to the roof rafter; and a connector assembly provided on the anchor clamp and adapted to selectively engage a connector secured to the worker's safety harness.

In another aspect, the disclosure may provide a safety system for securing a worker to a roof rafter; said safety system comprising a safety harness wearable by the worker; a lanyard connected at a first end to the safety harness and having a connector provided at a second end thereof; an anchor clamp engageable on a section of a roof truss rafter; said anchor clamp comprising a first side wall adapted to be positioned adjacent a first side of the roof rafter; a second side wall adapted to be positioned adjacent a second side of the roof rafter; a fastener assembly securing the first and second side walls together; and a connector assembly provided on the anchor clamp; wherein the connector from the safety harness is selectively engageable with the connector assembly.

In another aspect, the present disclosure may provide a method of securing a worker to a section of a roof truss comprising engaging an anchor clamp to a rafter of the roof truss comprising steps of positioning a middle wall of the anchor clamp against an upper surface of a section of the rafter; positioning a first side wall extending outwardly from one side of the middle wall adjacent a first side surface of the rafter; positioning a second side wall extending outwardly from an opposite side of the anchor's clamp's middle wall adjacent a second side surface of the rafter; engaging a fastener between the first side wall and the second side wall; and engaging a connector provided at one end of a lanyard extending from a worker's safety harness to the anchor clamp.

The step of engaging the anchor clamp to the rafter further comprises positioning a first slot defined in a lower end of the first side wall of the anchor clamp a distance below a lower surface of the rafter; positioning a second slot defined in a lower end of the second side wall of the anchor clamp a same distance below the lower surface of the rafter; at least partially aligning the first slot with the second slot; extending a fastener through the at least partially aligned first slot and second slot; and securing the fastener to the first and second side walls of the anchor clamp.

The step of engaging the connector may further comprise moving the anchor clamp outwardly relative to the upper surface of the rafter; separating the middle wall of the anchor clamp from the upper surface of the rafter; inserting the connector through a hole defined in the anchor clamp's middle wall; and moving the anchor clamp downwardly so that the middle wall is positioned adjacent the upper surface of the rafter.

The method may further comprise locating an anchor clamp cover provided on a roof; disengaging the cover from the roof; exposing a hole beneath the cover; locating, through the hole, the anchor clamp mounted on the roof rafter; and inserting the connector through the hole in the roof prior to engaging the connector with the anchor clamp. Still further, middle wall may comprise a protector plate separate from the first side wall and the second side wall; and said method further comprises passing a shaft of a second fastener through a bore defined by the protector plate and through aligned holes in the first and second side walls of the anchor clamp.

In yet another aspect, the present disclosure may provide a roof truss anchor clamp for use with a worker's safety harness; said anchor clamp comprising a U-shaped member comprising a middle wall adapted to be positioned adjacent an upper surface of a section of a roof truss rafter; a first side wall extending outwardly from one end of the middle wall; and a second side wall extending outwardly from an opposite end of the middle wall; wherein a space is defined between the first and second side walls and is adapted to receive the section of the rafter therein; a fastener assembly provided on the first and second side walls; and a connector assembly provided on the middle wall.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which may be fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a top perspective view of roof incorporating a first embodiment of an anchor clamp in accordance with an aspect of the present disclosure; the figure shows a worker in a safety harness crouching on the roof and getting ready to secure his safety lanyard to the anchor clamp;

FIG. 2 is a perspective view of the first embodiment anchor clamp in accordance with an aspect of the present disclosure;

FIG. 3 is a front elevational view of the anchor clamp;

FIG. 4 is a right side elevational view of the anchor clamp;

FIG. 5 is a top plan view thereof;

FIG. 6 is a bottom plan view thereof;

FIG. 7 is a front elevational view of the anchor clamp shown mounted on a side surface of a rafter of a roof truss, with the anchor clamp shown in a first position;

FIG. 8 is a cross-section taken along line 8-8 of FIG. 7;

FIG. 9 is a front view of the anchor clamp mounted on a rafter of a roof truss in a second position where a safety anchor is engaged with the anchor clamp;

FIG. 10 is a cross-section taken along line 10-10 of FIG. 9;

FIG. 11 is a perspective view of a second embodiment of an anchor clamp in accordance with an aspect of the invention;

FIG. 12 is a side elevational view thereof;

FIG. 13 is a front elevational view thereof;

FIG. 14 is a front elevational view of an anchor clamp assembly that may include two anchor clamps, engaged with a anchor plate that is secured to a truss in an off-peak position; and where the anchor clamp assembly is shown in a retracted position;

FIG. 15 is an enlargement of the highlighted region of FIG. 14;

FIG. 16 is an enlarged front elevational view of the anchor clamp assembly shown in a protracted position;

FIG. 16A is an enlarged front elevational view of the anchor clamp assembly shown in a protracted position, wherein the assembly also may include a crossover plate that is engaged with the anchor clamp and the anchor plate;

FIG. 17 is a side elevational view of the anchor clamp assembly shown in FIG. 16;

FIG. 17A is a side elevational view of the anchor clamp assembly shown in FIG. 16A;

FIG. 18 is a front elevational view of the anchor clamp assembly showing a fall arrest event;

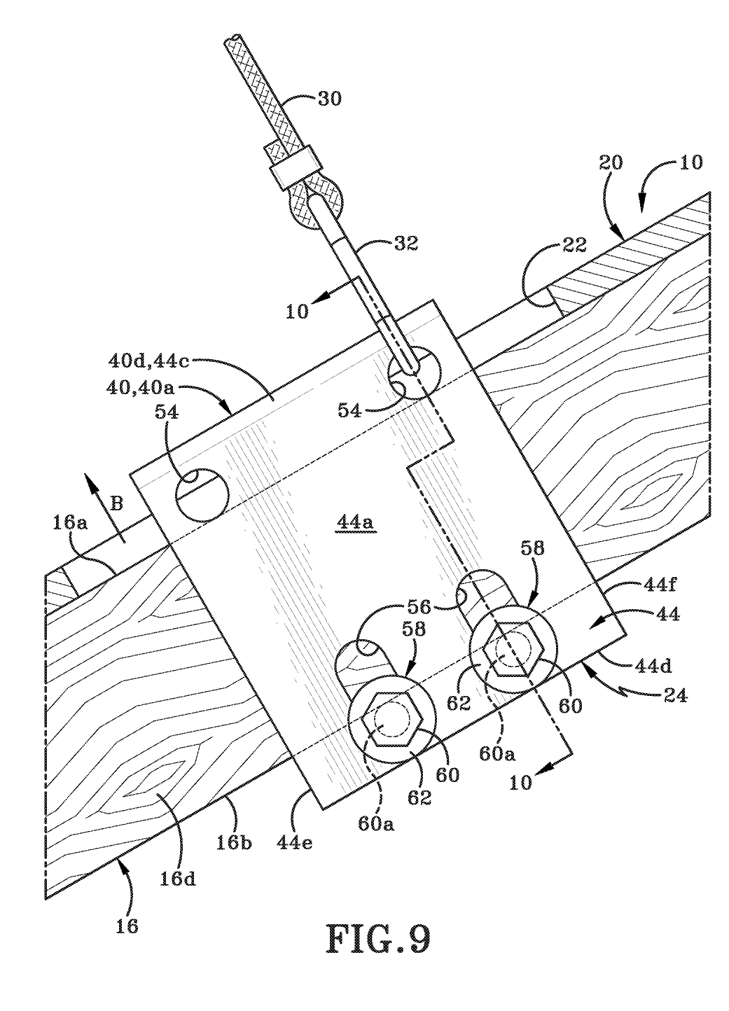

FIG. 9 is a front elevation view of a first embodiment of a protector plate for use with the anchor clamp; and where the protector plate is shown on its own;

FIG. 20 is a cross-section of the protector plate taken along line 20-20 of FIG. 19;

FIG. 21 is an enlarged front elevational view of the anchor clamp assembly that includes the protector plate of FIG. 19 shown positioned on a upper surface of a rafter chord;

FIG. 22 is a front elevation view of a second embodiment of a protector plate shown on its own;

FIG. 23 is a cross-section of the protector plate taken along line 23-23 of FIG. 22;

FIG. 24 is an enlarged front elevational view of the anchor clamp assembly that includes the protector plate of FIG. 22;

FIG. 25 is a front elevation view of a third embodiment of the protector plate shown on its own; and

FIG. 26 is a cross-section of the protector plate taken along line 26-26 of FIG. 25;

FIG. 27 is an enlarged front elevational view of the anchor clamp assembly using the protector plate of FIG. 25; and

FIG. 28 is an enlarged front elevational view of the anchor clamp assembly that includes the first embodiment of the anchor clamp and the third embodiment of the protector plate.

### DETAILED DESCRIPTION

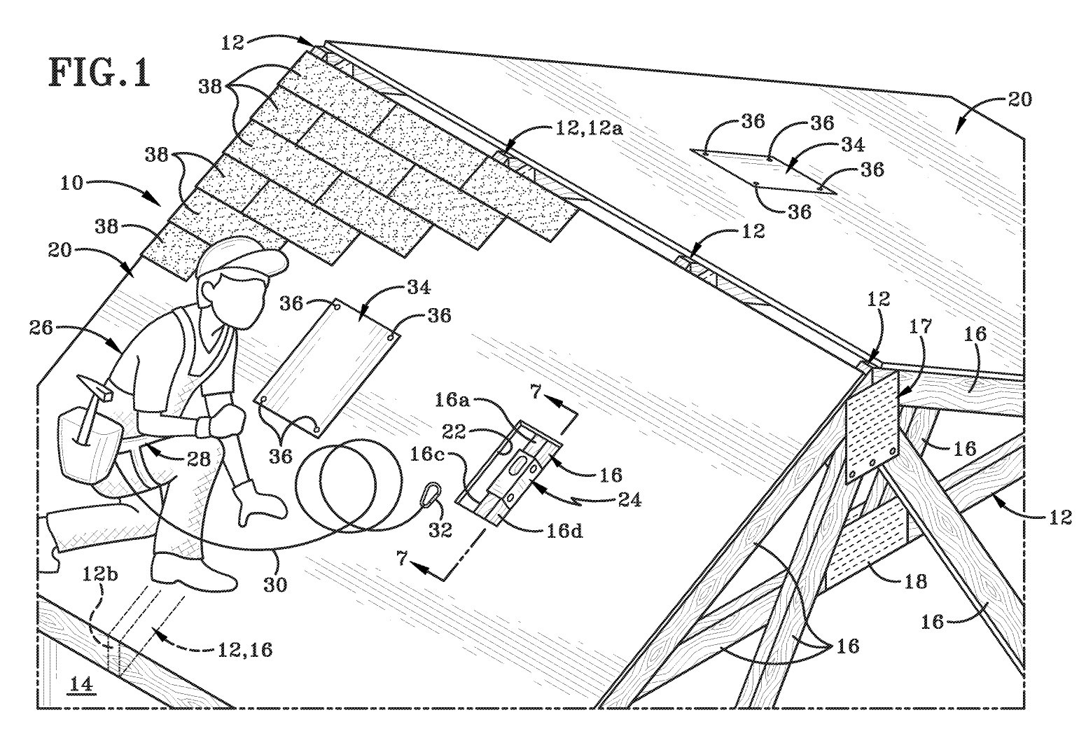

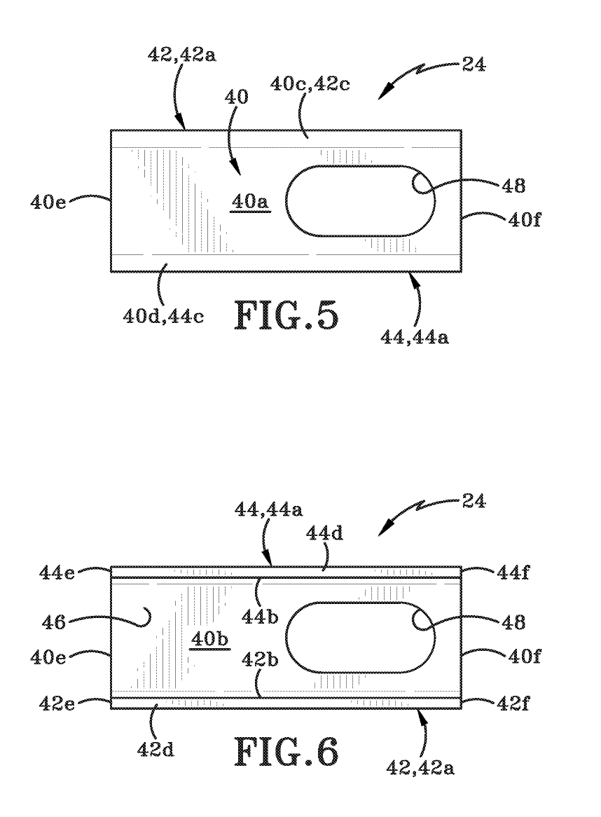

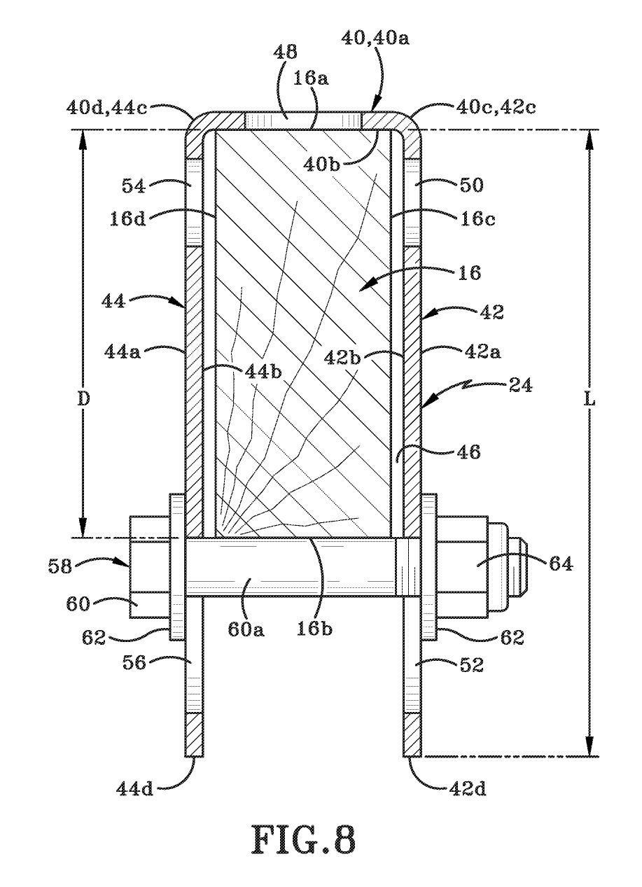

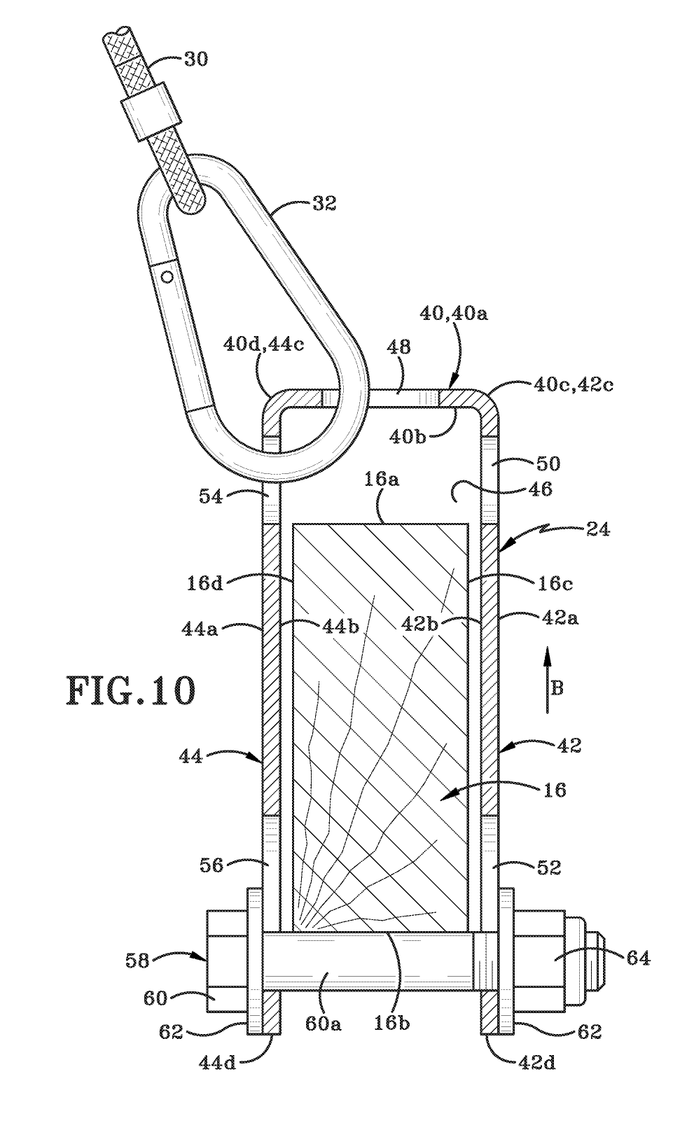

FIGS. 1-27 show an anchor clamp assembly in accordance with the present disclosure. Referring to FIG. 1, there is shown a roof 10 of a building. Roof 10 is comprised of a plurality of roof trusses 12 erected onto previously installed wall frames 14. Each truss 12 is comprised of a plurality of rafters or chords 16 that may be joined together by various metal plates 18 or any other suitable type of joining mechanism. Each truss 12 has an apex 12a and ends 12b. Ends 12b may be engaged with wall frame 14. (Only one of ends 12b is illustrated in FIG. 1 but it will be understood that the opposite end of truss 12 is similarly mounted to an opposed wall frame.) FIG. 8 shows each rafter 16 has an upper surface 16a, a bottom surface 16b, a first side surface 16c, and a second side surface 16d. Roof 10 is further comprised of a plurality of planar sheets 20, such as plywood sheets, that may be secured to rafters 16. Sheets 20 may be supported on upper surfaces 16a of a plurality of rafters 16 and may be secured to upper surfaces 16a of those rafters in any appropriate manner known in the art.

In accordance with an aspect of the current disclosure, one or more holes 22 may be cut into the plywood sheets 20. These holes 22 may be provided to allow access to a particular section of at least one rafter 16 and to the anchor clamp mounted thereon. The anchor clamp is identified in the figures and in this description by the reference number 24 and will be described in greater detail hereafter. Anchor clamp 24 may be installed on a section of rafter 16 that is located approximately midway between apex 12a and the end 12b of truss 12 which is engaged with wall frame 14. Anchor clamp 24 may therefore be referred to as a “mid-truss anchor clamp”.

Anchor clamp 24 may be used by a worker 26 to secure himself or herself while he or she works on the roof 10. The worker 26 puts on a safety harness 28. A lanyard 30 is connected at one end to safety harness 28 and a second end of lanyard 30 may include a safety harness connector 32 such as a carabiner or D-clip. Connector 32 is selectively engaged with anchor clamp 24 (as will be later described herein), thereby securing worker 26 to rafter 16. Once worker 26 has finished working on roof 10, he or she may place an anchor clamp cover 34 over hole 22 and use fasteners 36 to secure cover 34 back to sheet 20 or to the roof truss As is evident from FIG. 1, a plurality of such covers 34 (and therefore associated holes 22 and anchor clamps 24) may be provided on a single roof 10. Each cover 34 closes off access to one of the holes 22 in roof 10 and this ensures that roof 10 will be substantially continuous. Shingles, roof tiles 38 or any other suitable finishing material may be applied over sheets 20 and covers 34 to complete the construction and finishing of roof 10. Once roof 10 is shingled, the positions of the various covers 34 and therefore of the various anchor clamps 24 may be hidden. During a later reroofing operation, when shingles 38 are removed, covers 34 will again be visible. Covers 34 may therefore provide an immediate reference to a new worker as to where they may be able to access an anchor clamp 24 to which they can secure their safety harness. In order to access anchor clamp 24, the future worker will disengage fasteners 36, remove cover 34 and thereby expose hole 22 and anchor clamp 24. The worker will then be able to tie off their own safety harness to the already installed anchor clamp 24. The method of placing the anchor clamp under the roofing and covers 34 protects the anchor clamp 24 from weathering, thereby preserving the device for future use. (It should be noted that prior art devices anchor devices were installed in such a way that parts of the prior art devices extended above the roofline thus exposing the metal to corrosive weather elements.)

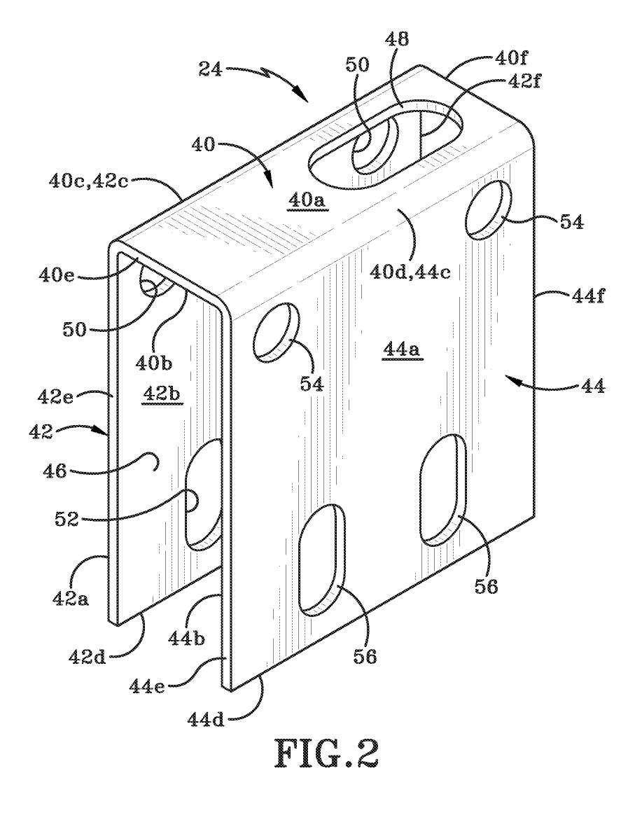

Referring now to FIGS. 2-6, anchor clamp 24 is described in greater detail. Anchor clamp 24 may be a generally U-shaped component that is integrally formed from metal. The U-shaped component may include a middle wall 40, a first side wall 42 and a second side wall 44. Middle wall 40 may have an exterior surface 40a, an interior surface 40b, a first side 40c, a second side 40d, a first end 40e and a second end 40f. First side wall 42 may include an exterior surface 42a, an interior surface 42b, a first side 42c, a second side 42d, a first end 42e, and a second end 42f. Second side wall 44 may include an exterior surface 44a, an interior surface 44b, a first side 44c, a second side 44d, a first end 44e, and a second end 44. First side 40c of middle wall 40 may be integral with first side 42c of first side wall 42 and form one corner of the U-shaped component. Second sides 42d, 44d may comprise terminal ends of the U-shaped component when that component is engaged on a section of rafter 16. Second side 40d of middle wall 40 may be integral with first side 44c of second side wall 44 and form another corner of the U-shaped component.

Each of the first and second side walls 42, 44 may extend outwardly from opposite sides 40c, 40d of middle wall 40 and be positioned a distance apart from each other. Each side wall 42, 44 may be oriented at about 90° relative to middle wall 40. Middle wall 40 and first and second side walls 42, 44 may bound and define a space 46 (FIG. 2) shaped and sized to receive a section of rafter 16 therein. Anchor clamp 24 may have a width “W” and a length “L” (FIG. 4). Width “W” may be at least as wide as rafter 16 (i.e., at least as wide as a distance between first and second side surfaces 16c, 16d of rafter 16). Length “L” of anchor clamp may be longer than a distance “D” (FIG. 8) between upper surface 16a and bottom surface 16b of rafter 16.

Referring again to FIGS. 2-6, middle wall 40a may define an elongate hole 48 therein. Hole 48 may be located closer to second end 40f than to first end 40e and is a through-hole extending between exterior and interior surfaces 40a, 40b. Hole 48 may be positioned equidistant from first and second sides 40c, 40d.

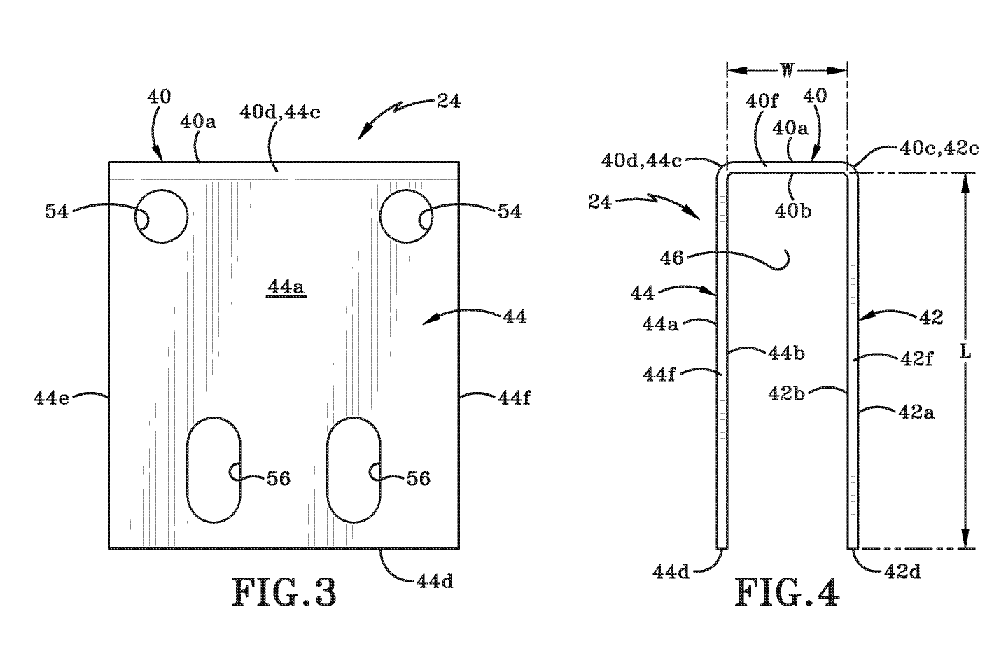

FIG. 3 shows that first side wall 42 may define a pair of spaced-apart apertures 50 and a pair of spaced apart slots 52 therein. Each aperture 50 may be a through-aperture extending between exterior and interior surfaces 42a, 42b and be located proximate an upper end of first side wall 42. Furthermore, each aperture 50 may be located a short distance inwardly away from first end 42c and one or the other of first and second sides 42e, 42f. Each slot 52 may be defined in a lower end of first side wall 42. Slots 52 may be through-slots extending between exterior and interior surfaces 42a, 42b. Each slot 52 may be located a short distance inwardly away from second end 42d and from one or the other of first and second sides 42e, 42f. Each slot 52 may be positioned so as to be vertically out of alignment with the one of the apertures 50 adjacent the same one of the first and second sides 42e, 42f. This is illustrated in FIG. 3. In other words, slot 52 may be located further away from the associated first or second side 42e, 42f than from the associated aperture 50.

Alternatively, slots 52 may be vertically aligned with the associated aperture 50 or may be located closer to the associated first or second side 42e, 42f than is the associated aperture 50. In other words, each slot 52 may be spaced the same distance away from the first or second side 42e, 42f as the associated aperture 50 or closer relative thereto.

In a similar fashion, a lower end of second side wall 42 may define a pair of spaced-apart apertures 54 and a pair of spaced apart slots 56 therein. Each aperture 55 may be a through-aperture extending between exterior and interior surfaces 44a, 44b. Furthermore, each aperture 55 may be located a short distance inwardly away from first end 44c and one or the other of first and second sides 44e, 44f. Slots 56 may be through-slots extending between exterior and interior surfaces 44a, 44b. Each slot 56 may be located a short distance inwardly away from second end 44d and one or the other of first and second sides 44e, 44f. Each slot 56 may be vertically out of alignment with the one of the apertures 54 adjacent the same one of the first and second sides 44e, 44f (as illustrated in FIG. 2). In other words, the slot 56 may be located further away from the associated first or second side 44e, 44f than is the associated aperture 54. Alternatively, the slots 56 may be vertically aligned with the associated aperture 54. In other words, each slot 56 may be spaced the same distance away from the first or second side 44e, 44f as the associated aperture 54. Additionally, holes 50 and 54 may be laterally aligned with each other and slots 52 and 56 may be laterally aligned with each other. This alignment may include the entire hole 50, 54 or only a portion thereof; and the entire slot 52, 56 or only a portion thereof.

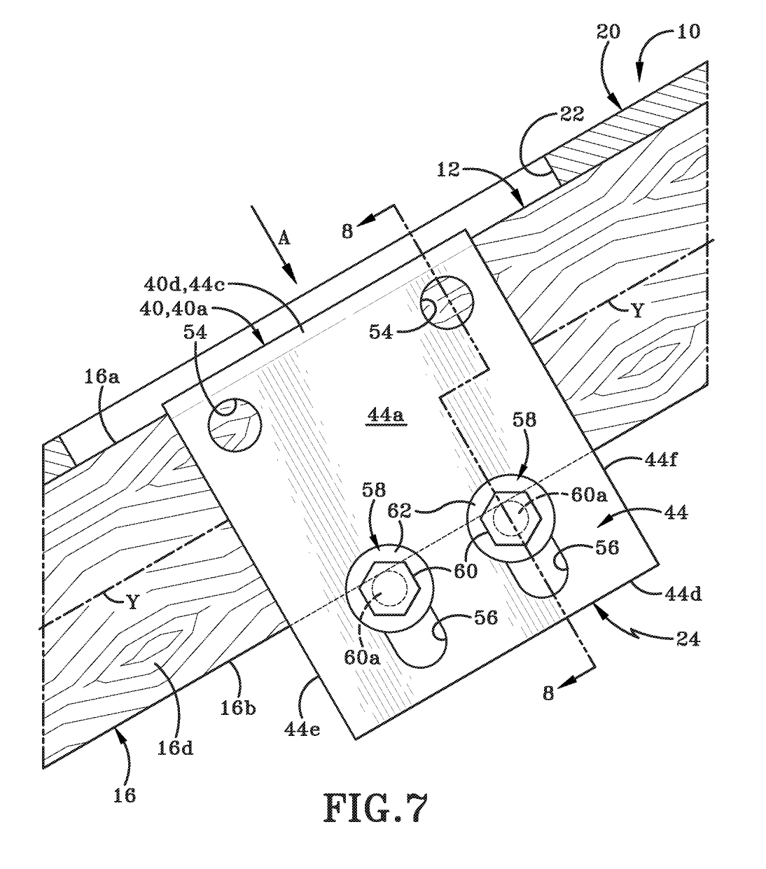

Referring to FIGS. 7-10 there is shown a method of installing and using anchor clamp 24. Anchor clamp 24 may be inserted through hole 22 in sheet 20 and be positioned against rafter 16. This may be accomplished by orienting anchor clamp 24 so that the U-shaped component may be located at right angles relative to a longitudinal axis “Y” (FIG. 7) of rafter 16 and so that clamp 24 may be positioned to receive a section of the rafter 16 into space 46. Anchor clamp 24 may be moved downwardly in the direction of arrow “A” until interior surface 40b (FIG. 8) is adjacent upper surface 16a of rafter 16. Anchor clamp 24 may be further positioned so that interior surface 42b of first side wall 42 may be adjacent first side surface 16c of rafter 16 and interior surface 44b of second side wall 44 may be positioned adjacent second side surface 16d of rafter 16.

Once anchor clamp 24 is in the above-mentioned position on rafter 16, a pair of fasteners 58 may be used to secure or lock anchor clamp 24 to rafter 16. Each fastener 58 may, for example, comprise a bolt 60, one or more washers 62, and a nut 64. The shaft 60a of each bolt 60 may be inserted through one of the slots 52 or 56 and may then be loosely tightened to secure the bolt 60 to anchor clamp 24 while still permitting relative movement between fastener 58 and anchor clamp 24.

FIG. 9 shows lanyard 30 from safety harness 28 being engaged with anchor clamp 24. In order to make this engagement, the worker 26 may pull anchor clamp 24 outwardly and upwardly away from upper surface 16a of rafter 16. This may be done by grasping the sides 42, 44 or bottom end 42d, 44d of clamp 24 and moving clamp 24 in the direction indicated by arrow “B”. Because slots 56 are elongate in the direction of this movement and because fasteners 58 may be only loosely tightened, anchor clamp 24 and bolts 58 will move upwardly in the direction of arrow “B”, thereby separating middle wall 40 of anchor clamp 24 from upper surface 16a of rafter 16. The movement in the direction of arrow “B” may continue until shafts 60a (FIG. 8) of bolts 60 contact bottom surface 16b of rafter 16. Further movement of anchor clamp 24 in the direction of arrow “B” will cause bolts 60 to slide along slots 56 until shafts 60a also contact the lowermost region of slots 56 and further movement is halted. When this occurs, most if not all of apertures 50, 54 may be positioned above upper surface 16a of rafter 16. The worker may then insert his or her safety system's connector 32 through one or both of apertures 54, or through one or both of apertures 52, or through hole 48 in middle wall 40, or through hole 48 and one of the apertures 54. Once connector 32 is so secured, the worker may let anchor clamp 24 go and anchor clamp 24 may slide downwardly back toward upper surface 16a of rafter 16 in the opposite direction to arrow “B”. The worker may additionally further tighten fasteners 58 to lock anchor clamp 24 in the position illustrated in FIG. 9. At this point, the worker is securely anchored to rafter 16 via anchor clamp 24. Allowing some slack in the positioning of anchor clamp 24 may be helpful for absorbing shock if the safety anchor system actually has to be utilized to arrest a fall.

Disengaging the safety harness assembly (i.e., harness 28, lanyard 30 and connector 32) from anchor clamp 24 requires simply reversing the above-mentioned steps. Similarly, removing anchor clamp 24 from rafter 16, if so desired, simply requires reversing the above-mentioned steps.

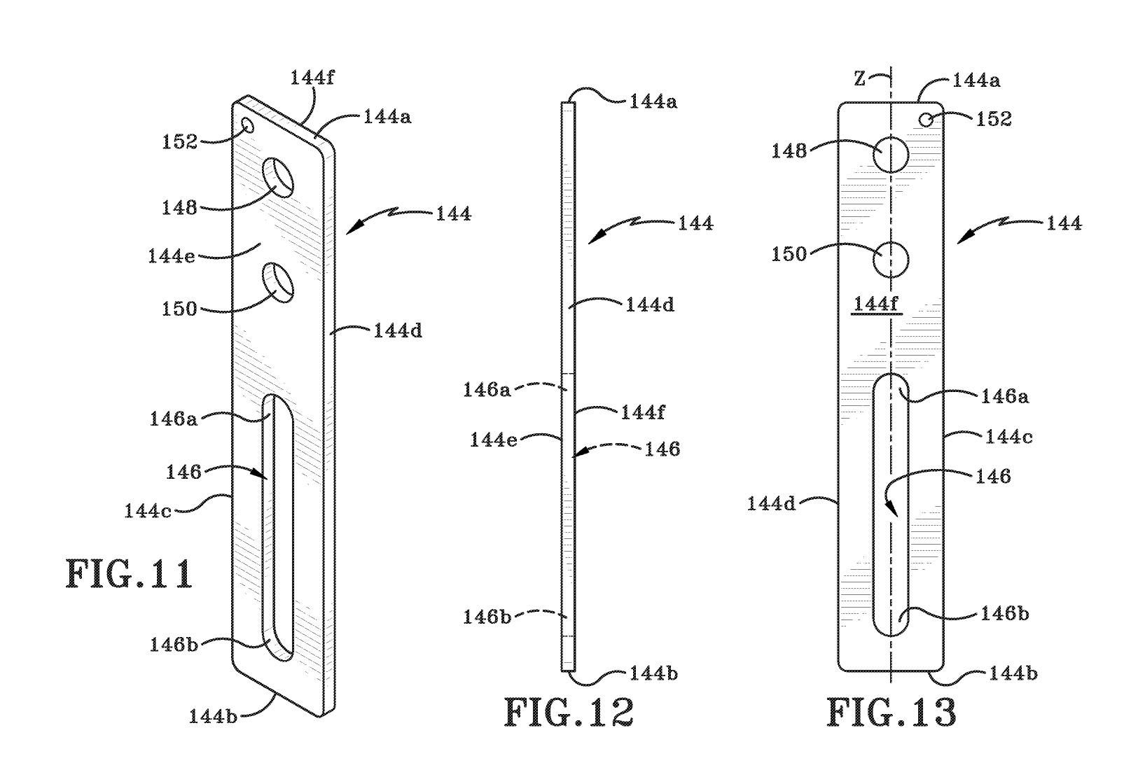

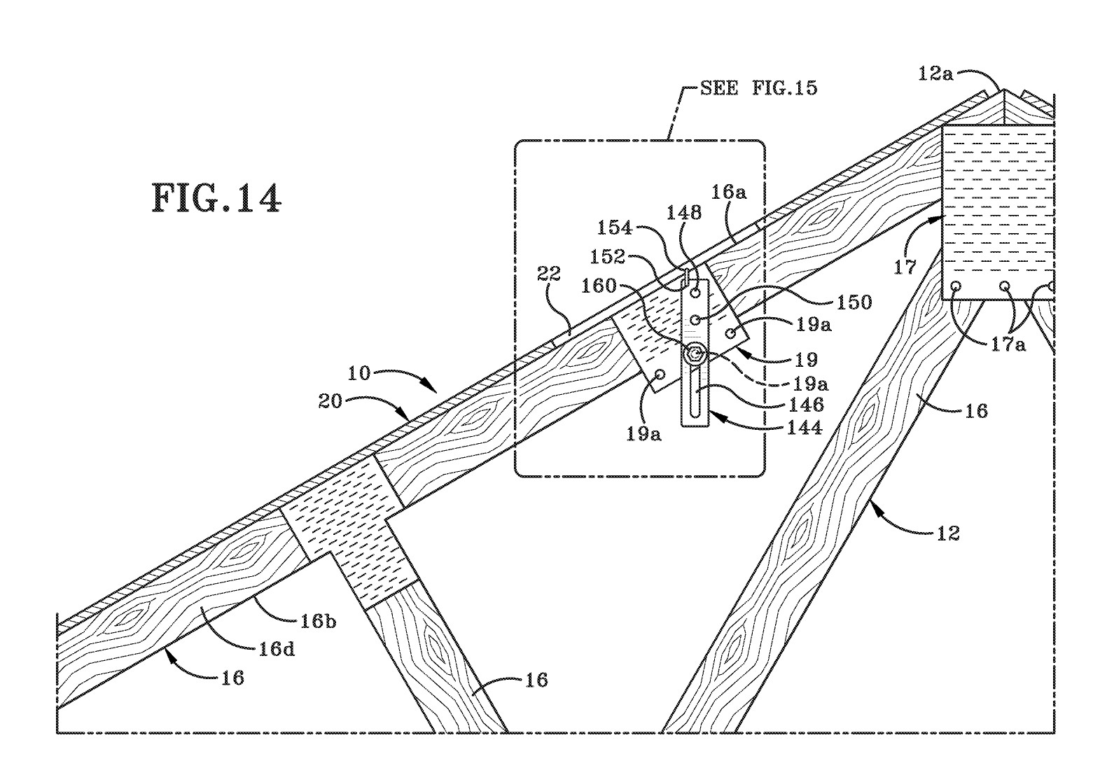

FIGS. 11-18 show a second embodiment of an anchor clamp in accordance with the present disclosure. This second embodiment of the anchor clamp is generally indicated in the following description and in the drawings by the reference number 144. Anchor clamp 144 may comprise one or two planar members that may be generally rectangular in shape. Two substantially identical anchor clamps 144 and a plurality of bolts, that will be described hereafter, make up an anchor clamp assembly 145. Assembly 145 may be used by a worker to secure a safety harness (28, 30, 32—FIG. 1) to an anchor plate 19 (FIG. 14) that is mounted on a beam 16 of truss 10. Anchor plate 19 may be located in an off-peak position (i.e., not at the peak of the truss). Alternatively, anchor clamp assembly 145 may be engaged with an on peak anchor plate such as anchor plate 17 (FIG. 1 or 14) or to any other suitable connector plate mounted on truss 10. Anchor plate 17 may define a plurality of holes 17a therein to which anchor clamp assembly 145 may be engaged. The anchor clamp assembly 145 and safety harness (28, 30, 32) may be used to arrest a fall of a worker from the roof 10.

Each planar member of anchor clamp 144 may be fabricated from steel and have an upper end 144a, a lower end 144b, a first side 144c, a second side 144d, an exterior surface 144e, and an interior surface 144f. A longitudinal axis “Z” may extend between upper end 144a and lower end 144b. An elongate slot 146 may be defined in the planar member and slot 146 may extend between interior and exterior surfaces 144e, 144f. Slot 146 may originate a short distance away from lower end 144b and extend longitudinally toward upper end 144a. Slot 146 may be substantially parallel to longitudinal axis “Z” and have a first end 146a and a second end 146b.

A first aperture 148 may be defined in the planar member a short distance downwardly from upper end 144a and at about a mid-point between first and second sides 144c, 144d. First aperture 148 may extend between exterior and interior surfaces 144e, 144f. A second aperture 150 may be defined a short distance downwardly from first aperture 148 and at about a mid-point between first and second sides 144c, 144d. Second aperture 150 may extend between exterior and interior surfaces 144e, 144f. First and second apertures 148, 150 may be longitudinally aligned with slot 146. First and second apertures 148, 150 may be spaced about one and a half inches apart from each other.

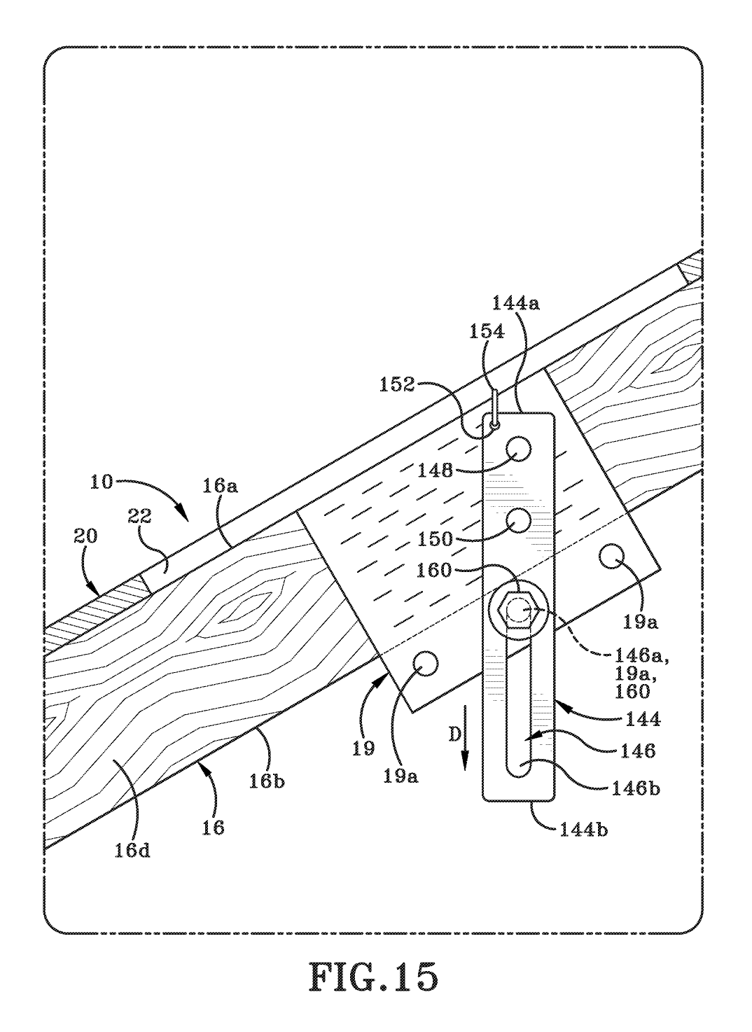

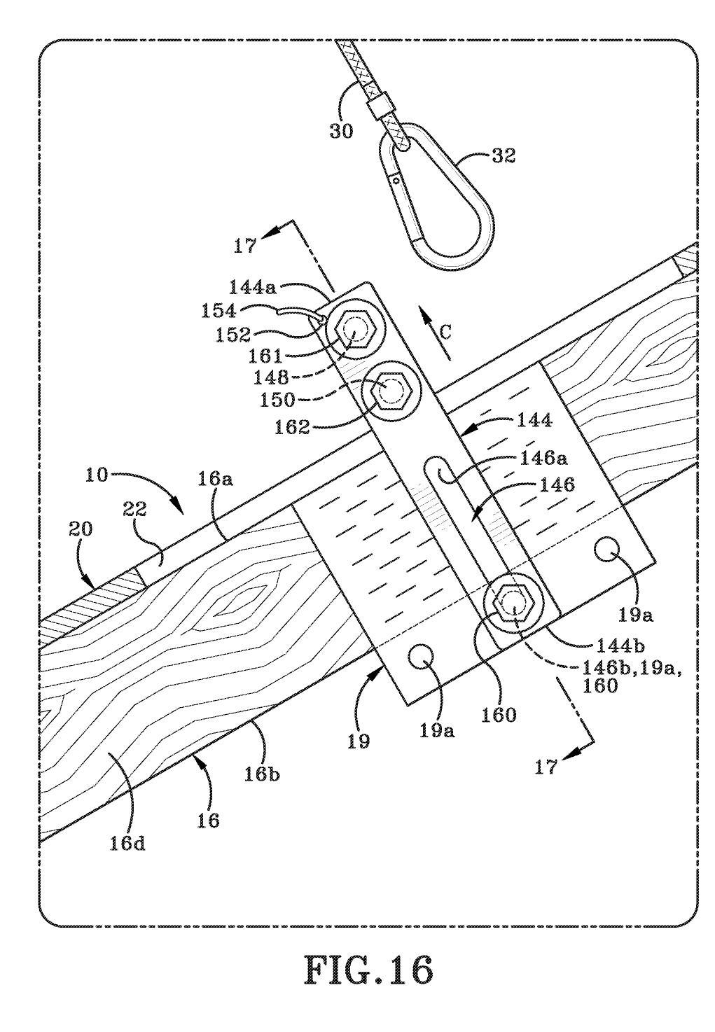

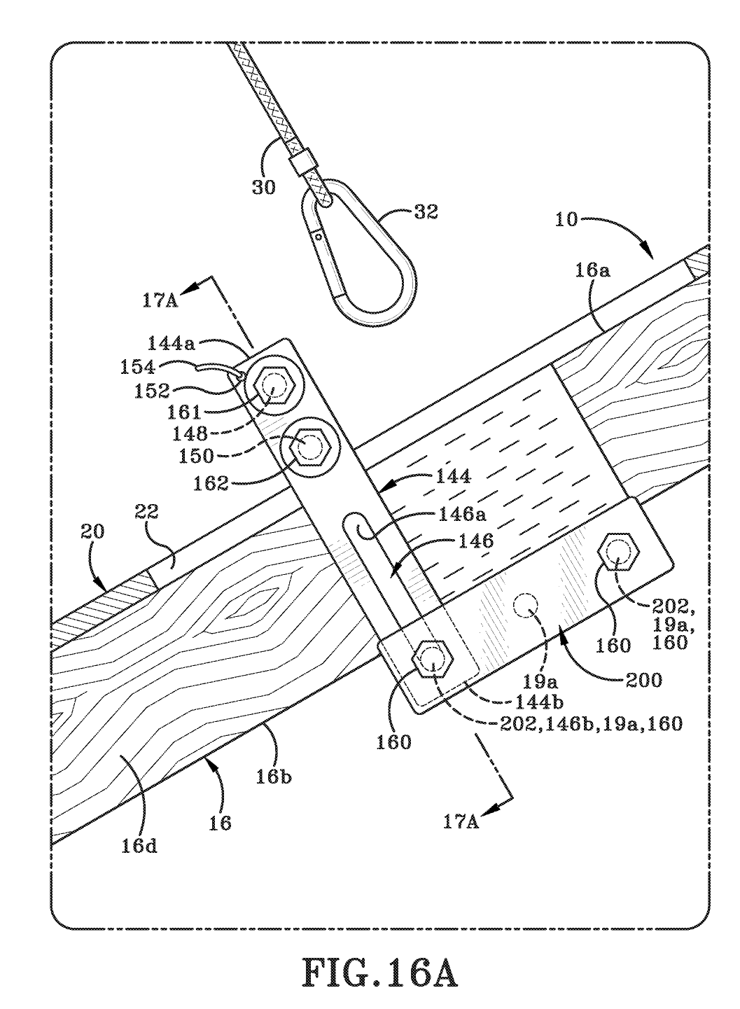

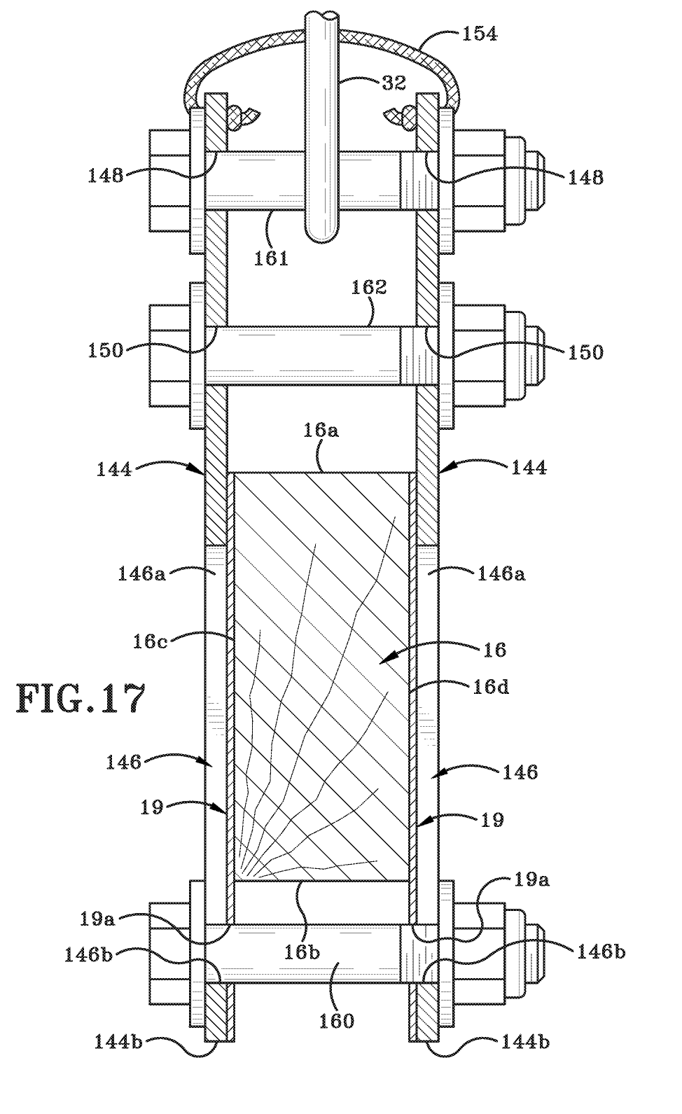

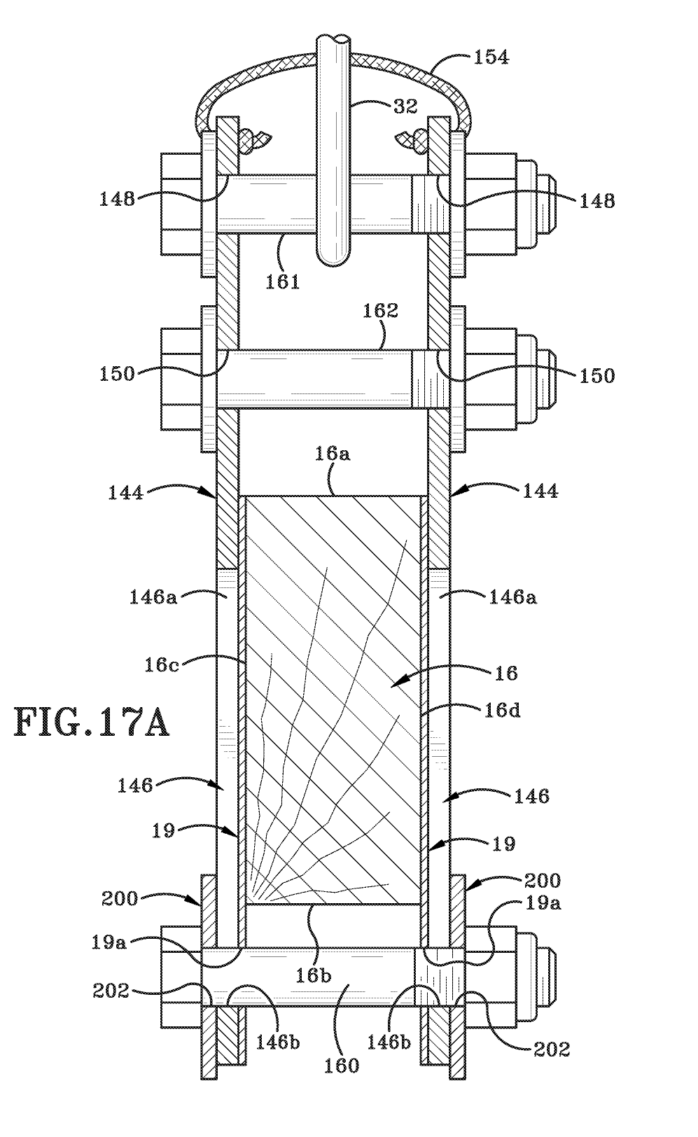

An opening 152 may be defined in planar member 144. Opening 152 may extend between exterior and interior surfaces 144e, 144f and may be located proximate a corner region of planar member 144. When two planar members 144 are used in anchor assembly 145, opening 152 defined in one planar member 144 may be aligned with opening 152 defined in the other planar member 1444. A grab-line 154 (FIGS. 14 and 17) may be threaded through each of the aligned openings 152, thus securing grab-line 154 to each planar member 144. Grab-line 154 may serve two purposes. Firstly, grab-line 154 may loosely secure the upper ends of the two planar members 144 together and, secondly, grab-line 154 may be easily grasped by a worker to pull planar members 144 upwardly and thereby move the planar members 144 from a retracted position (FIGS. 14 and 15) to a protracted position (FIG. 16).

If anchor clamp 144 is comprised of only a single planar member, then the fastener assembly may comprise slot 146, second aperture 150, a first bolt 160 and a second bolt 161. First bolt 160 (FIG. 14) may be inserted through slot 146 and through a hole defined in an anchor plate 19 that is fixedly engaged with rafter 16 or into one of the sides 16c, 16d of rafter 16. In some instances first bolt 160 may be positioned so as to extend below the lower surface 16b of rafter 16. A second bolt 161 may be inserted into a second hole defined in anchor plate 19 or into one of the sides 16c, 16d of roof truss. First aperture 148 may comprise part of the connector assembly and may receive connector 32 from a worker's safety harness therethrough.

In other instances, anchor clamp 144 may comprise two planar members. A first one of the planar members comprises a first side wall of the anchor clamp 144 and is positioned adjacent a first surface of rafter 16. A second one of the planar members comprises a second side wall of the anchor clamp 144 and is positioned adjacent a second surface of rafter 16. The fastener assembly may be used to secure the first planar member (first side wall) and the second planar member (second side wall) together. The connector assembly may then be engaged with one or the other or both of the first planar member and the second planar member. The fastener assembly may comprise a first bolt 160 and a second bolt 161 and slots 146 and one of the apertures 148, 150 of the pair of substantially identical anchor clamps 144. First bolt 160 may be inserted through slots 146 and be positioned below bottom surface 16b of rafter 16. Second bolt 161 may be inserted through aligned second apertures 150 and be positioned above upper surface 16a of rafter 16. A third bolt 162 and the first apertures 148 may comprise the connector assembly. The third bolt 162 may be inserted through the first apertures 148 and connector 32 may be passed around the shaft of third bolt 162. Appropriate nuts and washers may be used to secure bolts 160-162 to anchor clamps 144. Anchor clamp 144 may be engaged with anchor plate 19 at a mid-truss position. Alternatively, anchor clamp 144 may be engaged with plate 18 at an apex position.

The following description is directed to engagement of two planar members of anchor clamp 144 with anchor plate 19. (Anchor plate 19 may be utilized to substantially prevent anchor clamp 144 from sliding down the rafter 16 to towards an end where the roof truss rafter 16 connects to the wall frame.) A first bolt 160 may be inserted through slot 146 on anchor clamp 144 and into a hole 19a defined in plate 19. First bolt 160 may be tightened to a sufficient degree to secure anchor clamp 144 to plate 19 but not to lock anchor clamp 144 in a fixed orientation relative to plate 19. When anchor clamp 144 is initially secured to plate 19, anchor clamp 144 may hang downwardly from first bolt 160 because of gravity and first bolt 160 may be positioned adjacent second end 146b of slot 146 as shown in FIG. 14. This downwardly hanging position may be regarded as a retracted position because anchor clamp 144 does not extend above upper surface 16a of beam 16. In this retracted position anchor clamp 144 may not be in a position useful to secure safety harness 28, 30, 32 thereto.

Anchor clamp 144 may be pivoted about first bolt 160 as indicated by arrow “C” in FIG. 16 from the retracted position (shown in phantom) to the protracted position. (When anchor clamp 144 subsequently moves back into the retracted position, movement from the position shown in solid lines to the position shown in phantom lines in FIG. 16 occurs by rotating anchor clamp 144 in the opposite direction.)

In the protracted position, a portion of anchor clamp 144, including upper end 144a thereof, may extend above upper surface 16a of beam 16 and first bolt 160 may be located adjacent first end 146a of slot 146. It should be noted that first bolt 160 is not disengaged from plate 19 in order to move anchor clamp 144 between the retracted and protracted positions. Instead, anchor clamp may rotate about an axis that extends along the shaft of first bolt 160. Anchor clamp 144 may be restrained from a full range of rotation by the attached grab-line 154. Grab-line 154 may contact an upper surface 16a of beam 16 as anchor clamp 144 rotates and will thus halt any continued rotational motion.

When anchor clamp 144 is in the protracted position, shown in FIGS. 16 and 17, both of the first and second apertures 148, 150 may be located above an uppermost end of anchor plate 19 and above upper surface 16a of beam 16. Each of the anchor clamps 144 of anchor clamp assembly 145 may be engaged with the anchor plate 19 located on a different side of beam 16. Both anchor clamps 144 may be rotated into the protracted position and a second bolt 161 may be passed through aligned first holes 148 in the two anchor clamps 144. A third bolt 162 may be passed through aligned second holes 150 in the two anchor clamps 144. Appropriate nuts and washers may secure bolts 161 and 162 in place. Once second and third bolts 161, 162 are securely engaged with anchor clamps 144, anchor clamp assembly 145 may be ready to be used.

As with the first embodiment, a connector 32 (such as a carabiner) may be engaged around second bolt 161, thereby securing lanyard 30 and safety harness 28 to anchor clamp assembly 145. It will be understood that anchor clamps 144, bolts 160, 161, 162 and connector 32 will be sized appropriately to be able to support the weight of a worker if they fall off the roof.

Referring now to FIGS. 16A and 17A, anchor clamp assembly 145 may further include a crossover plate 200 that may be engaged with anchor clamp 144 and anchor plate 19. Crossover plate 200 may be a generally rectangular strip of metal that defines two or more holes 202 therein. FIGS. 16 and 17 show that bolt 160 may secure anchor clamps 144 to anchor plates 19 using nuts and washers. FIGS. 16A and 17A show that when crossover plate 200 is utilized in anchor clamp assembly 145, the bolt 160 may be removed from anchor clamps 144. Each washer is removed and may be replaced with one of the two connector plates 200. Bolt 160 may then be inserted through the aligned holes 202 in connector plates 200 and the holes 19a in anchor plates 19 and slot 146 of each anchor clamp 144. The nut may then be engaged with bolt 160. A second bolt 160 may be inserted through the second hole 202 in connector plates 200, through the holes 19a in anchor plates 19 and be secured in place using a second nut. Crossover plate 200 may thus be secured to anchor plates 19 by two bolts 160 and to anchor clamp 144 by one bolt 160. Crossover plate 200 may serve the purpose of preventing anchor clamp 144 from disengaging from anchor plate 19 during an arrest event.

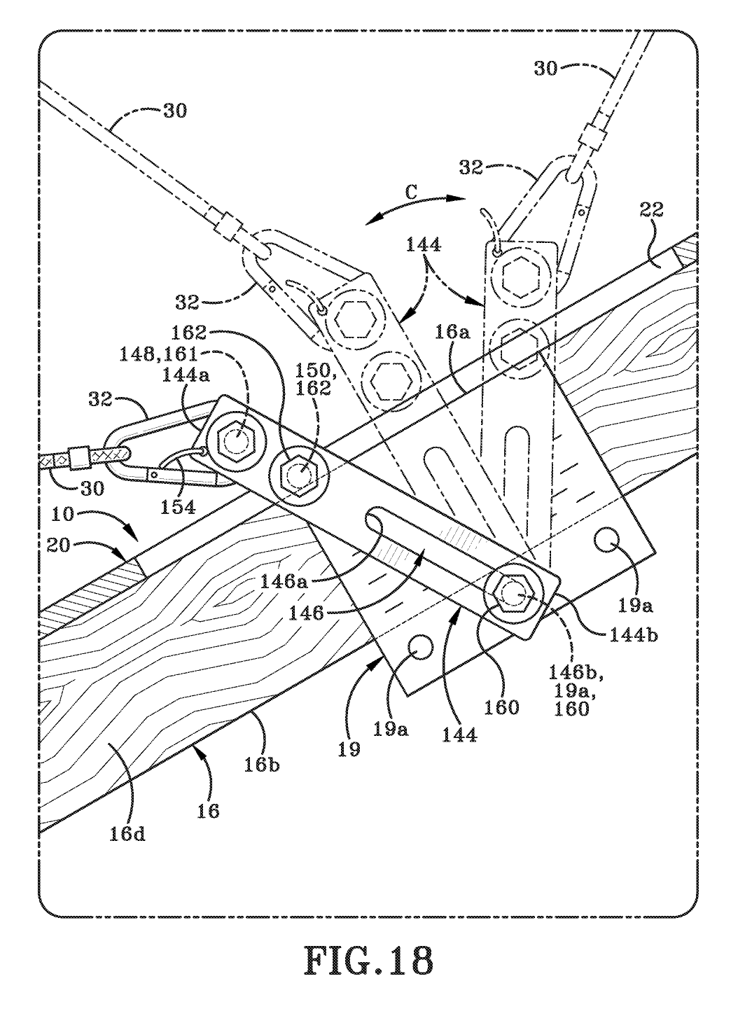

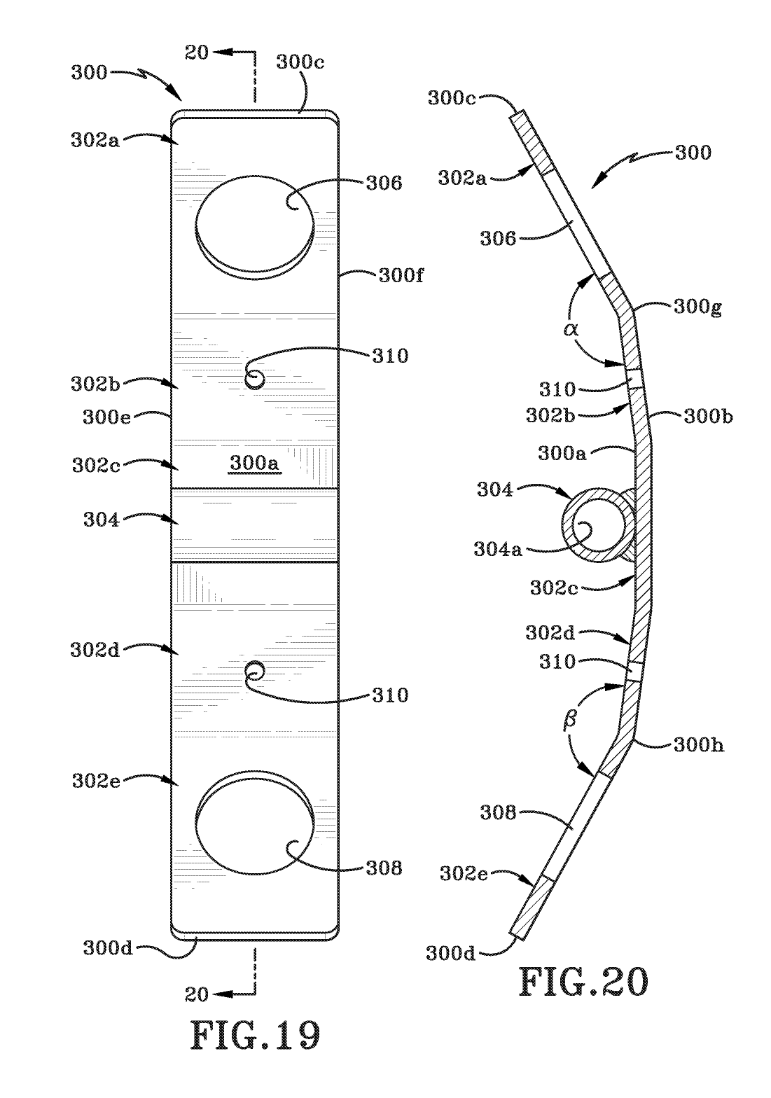

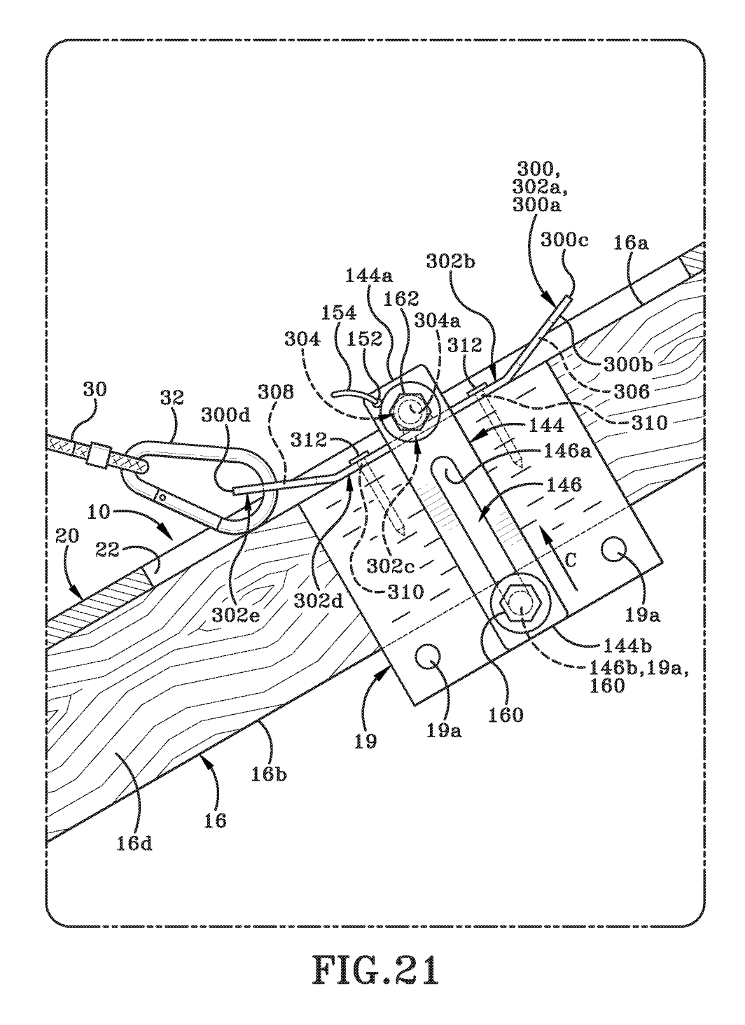

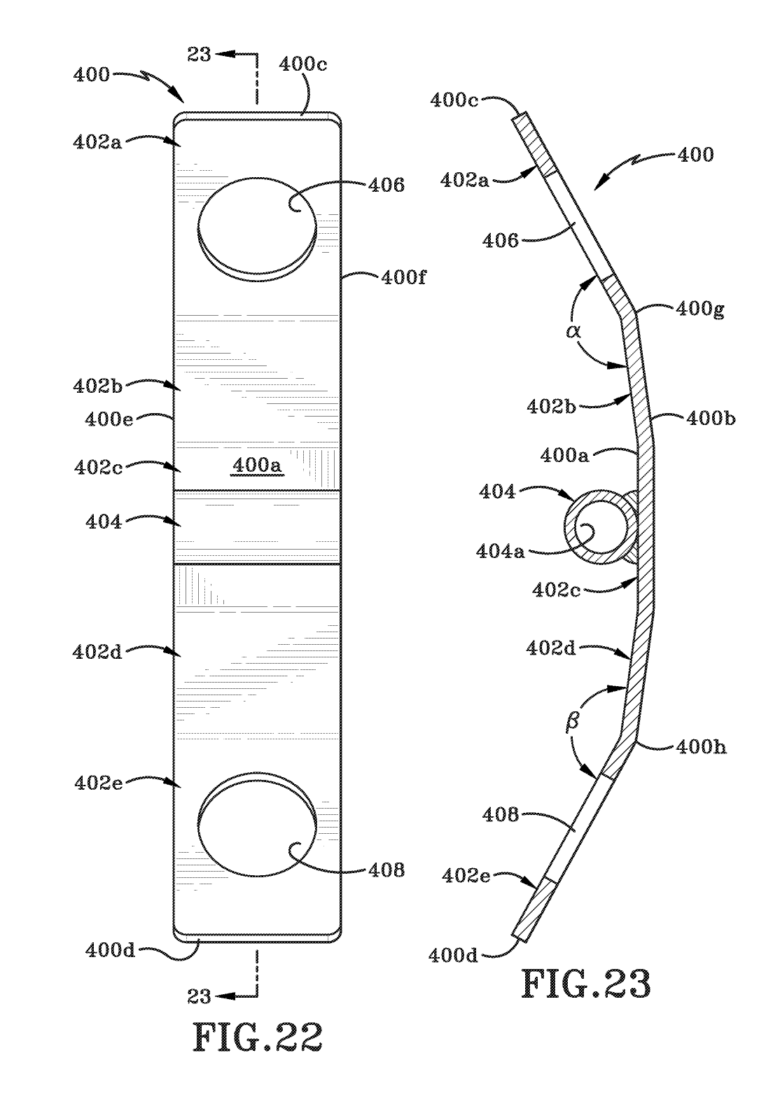

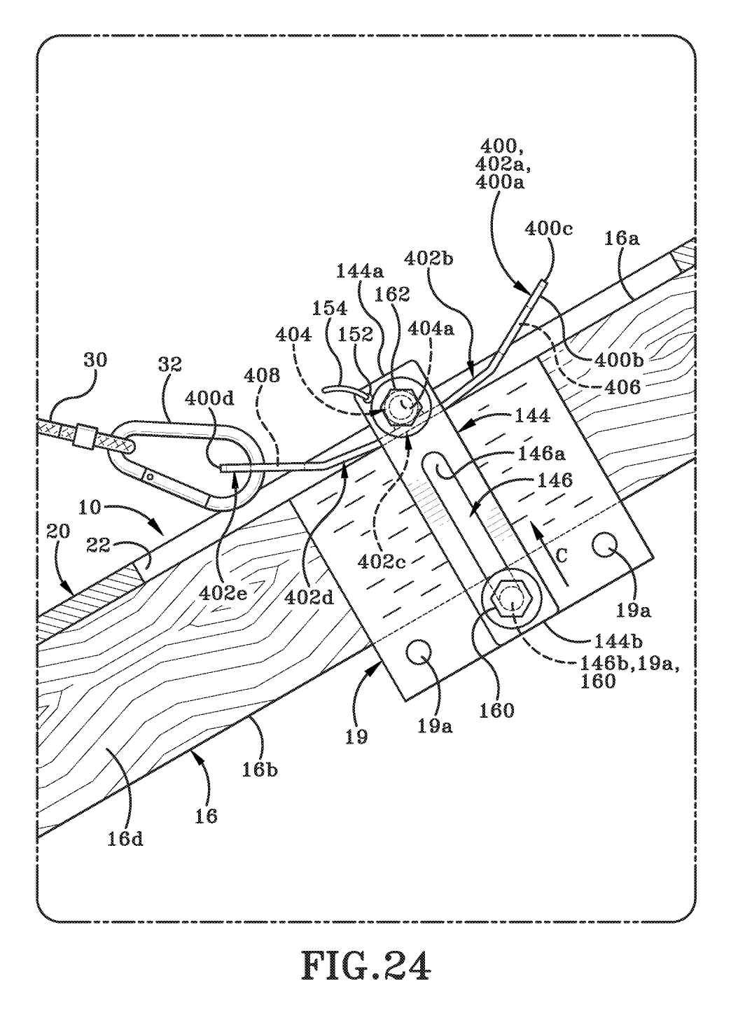

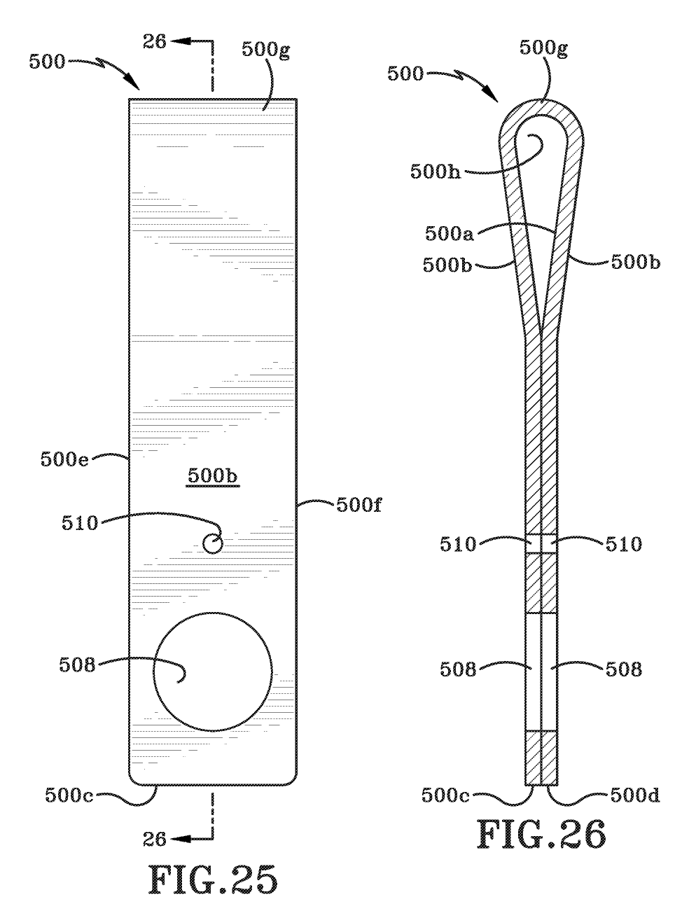

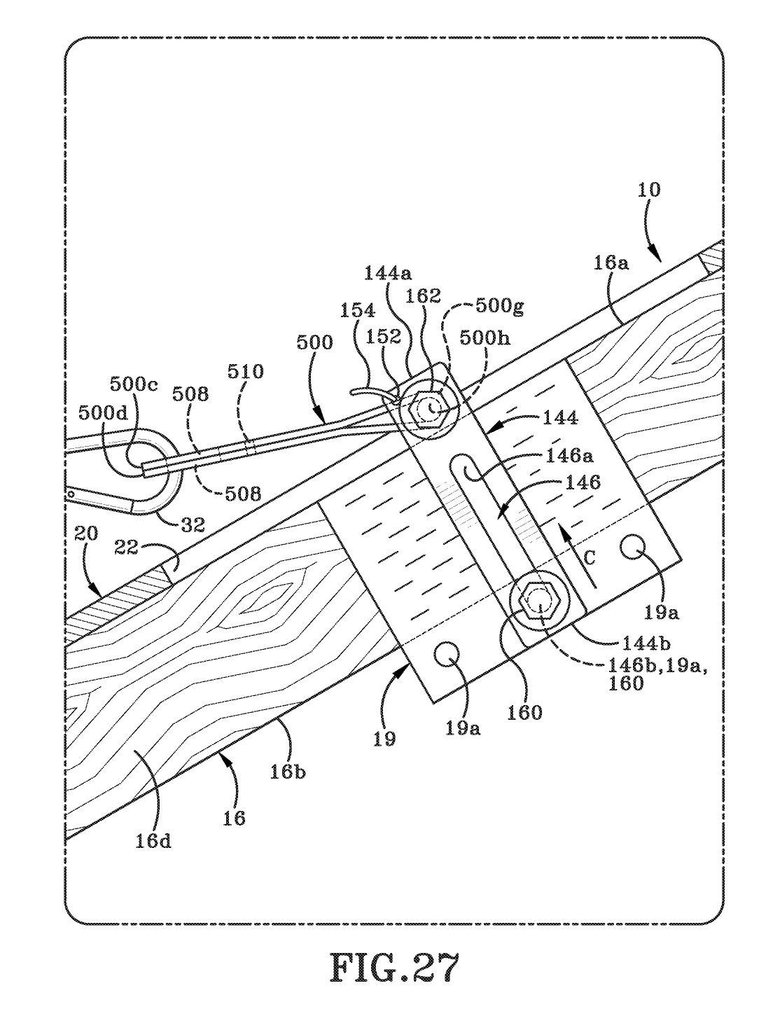

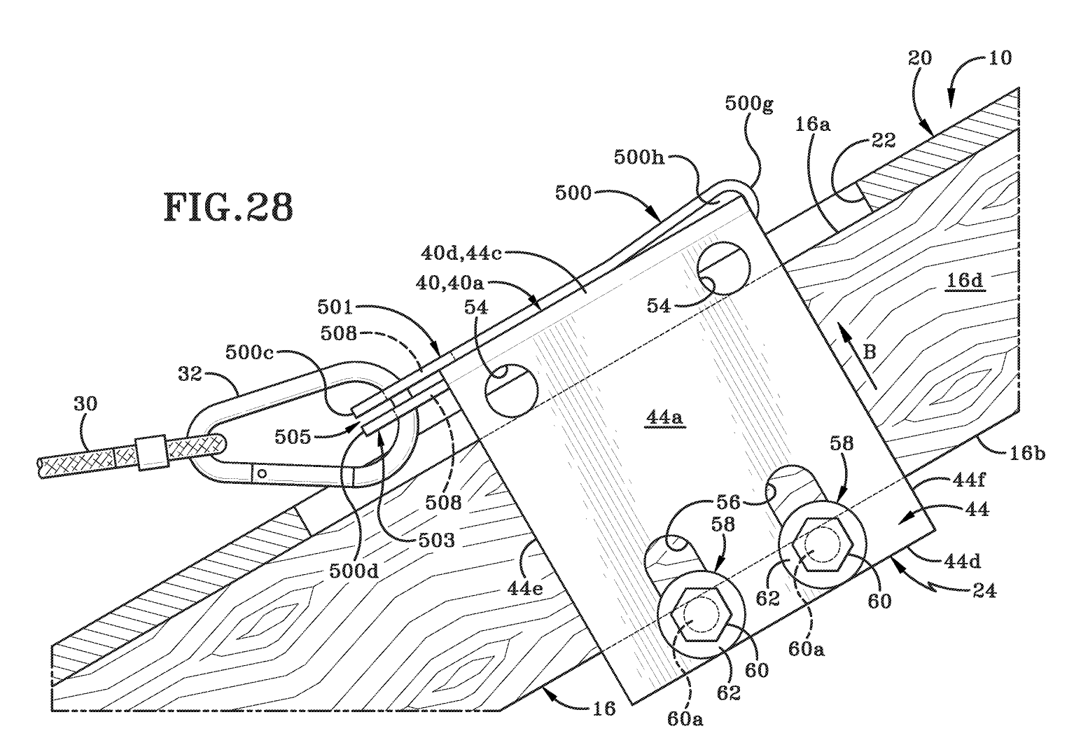

If a worker falls off the roof, the secured safety harness 28, 30, 32 may be used to arrest his or her fall. This is known as a fall arrest event and is illustrated in FIG. 18. During the fall arrest event, the third bolt 162 acts as a bearing bolt that abuttingly contacts upper surface 16a of beam 16 and serves as an stop or anchor for halting the motion of the falling worker. The rotational motion of anchor clamp 144 about first bolt 160 is shown in phantom and the arrested position is shown in solid in FIG. 18. After a fall arrest event the anchor clamp assembly 145 should be disengaged from truss 10 and a new anchor clamp assembly 145 should be engaged therewith. This is done because the assembly 145 may have been weakened by the fall arrest and may therefore be unable to adequately arrest a fall for a second time.

When a worker is finished working on the roof, anchor clamp assembly 145 must either be removed from truss 10 or be moved to a position where it no longer protrudes above an uppermost surface of any planar sheets 20. Anchor clamp assembly 145 is designed to remain engaged with truss 10 at all times. In order to ensure that assembly 145 does not protrude above planar sheets 20, anchor clamps 144 may be moved into the retracted position. In order to do this the second and third bolts 161, 162 may be removed from first and second apertures 148, 150, respectively, and anchor clamps 144 may be rotated downwardly to the retracted position shown in FIG. 14. Second and third bolts 161, 162 may then be re-engaged with anchor clamps 144 when in this retracted position by passing them through the respective aligned holes 148, 150. Alternatively, as illustrated herein, second and third bolts 161, 162 may not be reengaged with anchor clamps 144. When it is later desired to use anchor clamp assembly 145 once again, anchor clamps 144 will be rotated back into the protracted position and new bolts 161, 162 will be utilized to secure the two anchor clamps 144 together. In the retracted position, the anchor clamps 144 may remain in an inaccessible position below the roof deck. When in the protracted position, the worker may access the connection point (bolt 161) for securement of the safety lanyard 30 thereto. Between uses, the roof opening 24 (FIG. 1) may be covered with a removable flashing of sheet metal or other weather-resistant material. This flashing or cover 34 is shown in FIG. 1. When cover 34 is removed to expose hole 22 in the roof 20, anchor clamp assembly 145 is once again accessible through that hole 22.

Anchor clamp assembly 145 should be fully inspected before engagement of safety lanyard 30 therewith, particularly if some time has passed between the engagement of anchor clamp assembly 145 on truss 10 and the securement of safety harness 28, 30, 32 thereto. This situation may occur when anchor clamp assembly 145 is engaged when the roof is initially constructed and must then be accessed several year later when a replacement roof is installed. The concealment of anchor clamp assembly 145 with cover 34 between uses may be a vital safety matter as concealment effectively prevents the use of anchor clamp assembly 145 by unqualified persons who have not been trained in the correct engagement and/or use of safety harnesses. Untrained individuals could be seriously harmed if they attempt to anchor themselves and accidentally do not follow the procedures correctly.

Using two anchor clamps 144 as anchor clamp assembly 145 instead of only one anchor clamp 144 may be safer for arresting a fall. Using a single anchor clamp 144 may be possible although this is less desirable. In this latter instance, a connector 32 may be secured directly to one of first or second holes 148, 150 of a single anchor clamp 144 that may be engaged with anchor plate 19 by way of a bolt 160. As indicated above, this is not the preferred manner of engaging a safety lanyard 30 to beam 16.

FIGS. 19-27 show that an anchor clamp assembly in accordance with the present disclosure may comprise anchor clamp 144 along with a protector plate that may be selectively positioned on upper surface 16a of rafter or chord 16 between the plate members of anchor clamp 144. The protector plate may be provided to protect the upper surface 16a of rafter 16 from potential damage when the anchor clamp is used to arrest a worker's fall. The protector plate may prevent bolts 161, 162, for example, from cutting into upper surface 16a during a fall arrest event.

FIGS. 19-21 illustrate a first embodiment of the protector plate that is generally indicated at 300. FIGS. 22-24 illustrate a second embodiment of the protector plate, generally indicated at 400. FIGS. 25-27 illustrate a third embodiment of the protector plate, generally indicated at 500. It will be understood that any of the protector plates 300, 400, 500 may be used with anchor clamp 144. FIGS. 19, 22 and 25 show the various embodiments of the protector plate 300, 400 and 500 used with anchor clamp 144. (It will be understood that in other instances, protector plates 300, 400, 500 may also be used with anchor clamp 24 and at one bolt that passes through apertures 50, 54.)

Referring to FIGS. 19-21, protector plate 300 may comprise a generally open U-shaped member having a first surface 300a, a second surface 300b, a first end 300c, a second end 300d, a first side edge 300e and a second side edge 300f. Protector plate may comprise five legs 302a, 402b, 302c, 302d and 302e that are each oriented at an angle relative to the adjacent legs so that the five legs each are located in slightly different planes. First leg 302a may extend from first end 300c to a first corner 300g; second leg 402b extends from first corner 300g to third leg 302c, fourth leg 302d extends from third leg 302c and meets fifth leg 302e at a second corner 300h. First leg 302a and second leg 402b may be oriented at an angle α relative to each other and fourth leg 302d and fifth leg 302e may be oriented at an angle β relative to each other. The angles α and β may be obtuse angles that may be of generally the same size or of different sizes. The angles α and β help ensure that first leg 302a and fifth leg 302e are space a distance away from upper surface 16a of roof rafter 16 so that a worker can easily engage a connector 32 therewith.

It will be understood that protector plate 300 may include fewer than five legs 302a-302e or more than five legs. For instance, protector plate 300 may include only three legs, where the middle leg is oriented so as to lay flat upon upper surface 16a of roof rafter 16 and the two end legs angle upwardly and outwardly from the middle leg and therefrom from upper surface 16a of roof rafter 16. Protector plate 300 may even comprise only two legs; one that lays on upper surface 16a and one that angles outwardly therefrom.

A cylindrical member 304 may be welded to approximately a middle region of third leg 302c and on the first surface 300a thereof. Cylindrical member 304 may extend from first side edge 300e to second side edge 300f of protector plate 300 and may define a bore 304a therethrough. Bore 304a may extend from first side edge 300e to second side edge 300f of protector plate. Bore 304a may be shaped and sized so that the shaft of bolt 162, for example, may be inserted therethrough when anchor clamp 144 is to be secured to rafter 16. Inserting bolt 162 through bore 304a effectively may secure protector plate 300 between anchor clamps 144. The first anchor clamp 144 may form a first side wall that extends along a first side surface 16c of roof rafter 16; the second anchor clamp 144 may form a second side wall that extends along a second side surface 16d of roof rafter 16; and protector plate 300 may form a middle wall that extends along upper surface 16a of roof rafter 16.

Protector plate 300 may also define a first aperture 306 in first leg 302a and a second aperture 308 in fifth leg 302e. First and second apertures 306, 308 may extend from first surface 300a through to second surface 300b. First and second apertures 306, 308 may be shaped and sized to selectively receive connector 32 from a worker's safety harness therethrough instead of having the connector 32 engage with bolt 162.

Protector plate 300 may further define one or more holes 310 in second leg 402b and fourth leg 302d. Holes 310 may extend from first surface 300a through to second surface 300b and may be shaped and sized to receive a nail or other fastener therethrough. The nails/fasteners may be utilized in order to secure protector plate 300 to upper surface 16a of rafter 16. When protector plate 300 is so secured to rafter 16 by nails, protector plate 300 may provide static tethering for the worker and additionally aids in helping to decelerate the speed of a worker who may fall while tethered to anchor clamp 144. It should be noted that when one or more nails 312 is engaged with protector plate 300, second leg 302b, third leg 302c and fourth leg 302d may all be caused to be oriented along the same plane.

FIG. 21 shows protector plate 300 secured to rafter 16 by nails 312 that extend at least partially through holes 310 in plate 300. Bolt 162 of anchor clamp 144 may be passed through bore 304a of cylindrical member 304, thereby securing protector plate 300 and anchor clamp 144 together. Connector 32 may be engaged with protector plate 300 by inserting part of connector 32 through aperture 306 or through aperture 308.

Protector plate 400 is illustrated in FIGS. 22-24. Protector plate 400 may be substantially identical to protector plate 400 except that the holes 310 may be omitted therefrom. Protector plate 400 may be a generally open U-shaped member having a first surface 400a, a second surface 400b, a first end 400c, a second end 400d, a first side edge 400e and a second side edge 400f. Protector plate may comprise five legs 402a, 402b, 402c, 402d and 402e that are each oriented at an angle relative to the adjacent legs so that the five legs each are located in slightly different planes. First leg 402a may extend from first end 400c to a first corner 400g; second leg 402b extends from first corner 400g to third leg 402c, fourth leg 402d extends from third leg 402c and meets fifth leg 402e at a second corner 400h. First leg 402a and second leg 402b may be oriented at an angle α relative to each other and fourth leg 402d and fifth leg 402e may be oriented at an angle β relative to each other. The angles α and β may be obtuse angles that may be of generally the same size or of different sizes. The angles α and β help ensure that first leg 402a and fifth leg 402e are space a distance away from upper surface 16a of roof rafter 16 so that a worker can easily engage a connector 32 therewith.

It will be understood that protector plate 400 may include fewer than five legs 402a-402e or more than five legs. For instance, protector plate 400 may include only three legs, where the middle leg is oriented so as to lay flat upon upper surface 16a of roof rafter 16 and the two end legs angle upwardly and outwardly from the middle leg and therefrom from upper surface 16a of roof rafter 16. Protector plate 400 may even comprise only two legs; one that lays on upper surface 16a and one that angles outwardly therefrom.

A cylindrical member 404 may be welded to approximately a middle region of third leg 402c and on the first surface 400a thereof. Cylindrical member 404 may extend from first side edge 400e to second side edge 400f of protector plate 400 and may define a bore 404a therethrough. Bore 404a may extend from first side edge 400e to second side edge 400f of protector plate. Bore 404a may be shaped and sized so that the shaft of bolt 162, for example, may be inserted therethrough when anchor clamp 144 is to be secured to rafter 16. Inserting bolt 162 through bore 404a effectively may secure protector plate 400 between anchor clamps 144. The first anchor clamp 144 may form a first side wall that extends along a first side surface 16c of roof rafter 16; the second anchor clamp 144 may form a second side wall that extends along a second side surface 16d of roof rafter 16; and protector plate 400 may form a middle wall that extends along upper surface 16a of roof rafter 16.

Protector plate 400 may also define a first aperture 406 in first leg 402a and a second aperture 408 in fifth leg 402e. First and second apertures 406, 408 may extend from first surface 400a through to second surface 400b. First and second apertures 406, 408 may be shaped and sized to selectively receive connector 32 from a worker's safety harness therethrough instead of having the connector 32 engage with bolt 162.

FIG. 24 shows protector plate 400 placed on upper surface 16a of rafter 16. In this instance, only third leg 402c contacts upper surface 16a and the first and second legs 402a, 402b and the fourth and fifth legs 402d and 402e angle upwardly away from upper surface 16a in opposite directions. Bolt 162 of anchor clamp 144 may be passed through bore 404a of cylindrical member 404, thereby securing protector plate 400 and anchor clamps 144 together. Connector 32 may be engaged with protector plate 400 by passing at least a portion of connector 32 through one of the apertures 406, 408 as previously described herein.

FIGS. 25-27 show protector plate 500 that may be used with anchor clamp 144. Protector plate 500 may be substantially identical to protector plate 300 except that instead of providing a generally open U-shaped member having a cylindrical member approximately midway between first end 500c and second end 500d; the metal of protector plate 500 is bent back upon itself to form a passageway for the shaft of bolt 162. Protector plate 500 may have a first surface 500a, a second surface 500b, a first end 500c, a second end 500d, a first side edge 500e and a second side edge 500f. Protector plate 500 is folded or bent back upon itself so that a first region of second surface 500b proximate first end 500c abuts a second region of second surface 500b proximate second end 500d. An arcuate bend 500g is formed approximately midway between first end 500c and second end 500d. Portions of the second surface 500b on either side of bend 500g do not abut each other but are spaced a distance apart such that an opening 500h is defined therebetween. Opening 500h may of a shape and size that will permit the shaft of bolt 162 to pass therethrough. An aperture 508 similar to apertures 306, 308 may be defined a short distance inwardly from each of the opposing ends 500c, 500d. When protector plate 500 is bent back upon itself, the apertures 508, 508 may be aligned and form a single opening through plate 500. Similarly, a hole 510 sized to receive a nail or other fastener may extend between the first and second surfaces 500a, 500b and be positioned a short distance further away from first end 500a or second end 500b than aperture 508. Again, when protector plate 500 is bent back upon itself, the two holes 510 may be aligned to form a single hole through which a nail or other fastener may be inserted. FIG. 25 shows that bolt 162 may be received through opening 500h to secure anchor clamp 144 and protector plate 500 together. A nail or other fastener may be received through openings 510 if desired. Connector 32 may be secured to protector plate 500 by passing at least a portion thereof through aperture 506, 508.

FIG. 28 illustrates a situation where protector plate 500 may be used in conjunction with anchor clamp 24 instead of with anchor clamp 144. In this particular instance protector plate 500 may be engaged with middle wall 40 of anchor clamp 24 such that a first arm 501 of protector plate 500 is located in contact with exterior surface 40a of middle wall 40 and a second arm 503 of protector plate 400 is in contact with interior surface 40b thereof. Second end 40f of middle wall 40 may be seated in the opening 500h defined by protector plate 500. The first and second arms 501, 503 may be forced a distance apart from each other such that a gap 505 is created between them. Gap 505 may be of a size that is generally equivalent to the thickness of middle wall 40; where the thickness is measured between exterior and interior surfaces 40a, 40b. The end regions of the arms 501, 503 may extend for a distance outwardly beyond first end 40e of middle wall 40 and the connector 32 may be passed through the aligned apertures 508, 508 defined in the first and second arms 501, 503.

Although not illustrated herein, it will be understood that a further embodiment of the protector plate may be substantially identical to protector plate 500 except that the holes 510 may be omitted therefrom.

In the foregoing description, certain terms have been used for brevity, clarity, and understanding. No unnecessary limitations may be to be implied therefrom beyond the requirement of the prior art because such terms may be used for descriptive purposes and may be intended to be broadly construed.

Moreover, the description and illustration set out herein may be an example and the invention is not limited to the exact details shown or described.

1. A roof truss anchor clamp for use with a worker's safety harness; said anchor clamp comprising:
a first side wall adapted to be positioned adjacent a first side surface of a roof rafter;
a fastener assembly that is adapted to secure the anchor clamp to the roof rafter; and
a connector assembly provided on the anchor clamp and adapted to selectively engage a connector secured to the worker's safety harness.

2. The roof truss anchor clamp as defined in claim 1, further comprising:
a second side wall adapted to be positioned adjacent a second side surface of the roof rafter; and
wherein the fastener assembly secures the first side wall to the second side wall.

3. The roof truss anchor clamp as defined in claim 1, wherein the anchor clamp further comprises:
a middle wall extending between the first and second side walls; and wherein the middle wall is adapted to be positioned adjacent an upper surface of the roof rafter.

4. The roof truss anchor clamp as defined in claim 1, wherein the connector assembly comprises an aperture defined in the first side wall, said aperture extending between an interior and exterior surface thereof; and wherein the aperture selectively receives the connector from the worker's safety harness therethrough.

5. The roof truss anchor clamp as defined in claim 1, wherein the connector assembly comprises an aperture defined in the second side wall, said aperture extending between an interior and exterior surface of the second side wall; and wherein the aperture selectively receives the connector from the worker's safety harness therethrough.

6. The roof truss anchor clamp as defined in claim 3, wherein the connector assembly comprises a hole defined in the middle wall, said hole extending between an interior and exterior surface of the middle wall; and wherein the hole selectively receives the connector from the worker's safety harness therethrough.

7. The roof truss anchor clamp as defined in claim 3, wherein the anchor clamp is an integrally formed U-shaped member and the first side wall extends outwardly from one end of the middle wall; and the second side wall extends outwardly from an opposite end of the middle wall; wherein a space is defined by the middle wall and first and second side walls; and wherein the space is adapted to receive a section of the roof rafter therein.

8. The roof truss anchor clamp as defined in claim 7, wherein the fastener assembly comprises a first slot defined towards a lower end of the first side wall and a second slot defined towards a lower end of the second side wall; wherein the first slot and the second slot are at least partially aligned with each other; and wherein the fastener assembly further comprises a fastener that is inserted through the first slot and the second slot.

9. The roof truss anchor clamp as defined in claim 8, wherein the fastener assembly further comprises a first aperture defined in the first side wall between the first slot and the middle wall; and the fastener assembly further comprises a second aperture defined in the second side wall between the second slot and the middle wall; and wherein the first aperture and the second aperture are at least partially aligned with each other; and wherein the fastener assembly further comprises a second fastener that is inserted through the first aperture and the second aperture.

10. The roof truss anchor clamp as defined in claim 9, wherein the first slot and the first aperture are spaced a distance apart that is greater than a distance between the upper surface and a lower surface of the roof rafter.

11. The roof truss anchor clamp as defined in claim 3, wherein the middle wall comprises a protector plate that is separate from the first side wall and the second side wall and wherein the protector plate defines a bore and wherein the fastener assembly further comprises a fastener that extends through the bore and connects the protector plate to the first and second side walls.

12. The roof truss anchor clamp as defined in claim 11, wherein the protector plate comprises:
a middle leg that is adapted to be positioned adjacent the upper surface of the roof rafter;
a first leg that is oriented at a first angle relative to the middle leg and extends outwardly therefrom in a first direction; and
a third leg that is oriented at a second angle relative to the middle leg and extends outwardly therefrom in a second direction; and wherein the connector assembly comprises an aperture that is defined in one or both of the first leg and the third leg; and wherein the aperture is adapted to selectively receive the connector from the worker's safety harness therethrough.

13. A safety system for securing a worker to a roof rafter; said safety system including:
a safety harness wearable by the worker;
a lanyard connected at a first end to the safety harness and having a connector provided at a second end thereof;
an anchor clamp engageable on a section of a roof truss rafter; said anchor clamp comprising:
a first side wall adapted to be positioned adjacent a first side of the roof rafter;
a second side wall adapted to be positioned adjacent a second side of the roof rafter;
a fastener assembly securing the first and second side walls together; and
a connector assembly provided on the anchor clamp; wherein the connector from the safety harness is selectively engageable with the connector assembly.

14. The safety system as defined in claim 13, further comprising a middle wall extending between the first and second side walls; and wherein the connector assembly further comprises an aperture defined in the middle wall, said aperture extending between an interior surface and an exterior surface of the middle wall; and wherein the aperture is adapted to receive the connector at the second end of the lanyard therethrough.

15. The safety system as defined in claim 13, further comprising a protector plate that extends between the first and second side walls.

16. The safety system as defined in claim 15, wherein the protector plate has a first surface, a second surface, a first end, a second end, a first side edge and a second side edge; wherein the first and second ends and the first and second side edges extend between the first surface and the second surface; and
wherein the protector plate is selectively engageable with the fastener assembly.

17. The safety system as defined in claim 16, wherein the protector plate defines a bore therethrough; and wherein the fastener assembly comprises a first fastener that is receivable through the bore and connects the first and second side walls.

18. The safety system as defined in claim 17, wherein the fastener assembly further comprises:
a first slot defined in the first side wall;
a second slot defined in the second side wall; wherein the first slot and the second slot are at least partially laterally aligned with each other and are located so as to be positioned a distance below a lower surface of the section of the roof truss rafter when the anchor clamp is engaged with the section of the roof truss rafter; and
a fastener selectively receivable through the at least partially aligned first slot and second slot in the first and second side walls.

19. A method of securing a worker to a section of a roof truss comprising:
engaging an anchor clamp to a rafter of the roof truss comprising steps of:
positioning a middle wall of the anchor clamp against an upper surface of a section of the rafter;
positioning a first side wall extending outwardly from one side of the middle wall adjacent a first side surface of the rafter;
positioning a second side wall extending outwardly from an opposite side of the anchor's clamp's middle wall adjacent a second side surface of the rafter;
engaging a fastener between the first side wall and the second side wall; and;
engaging a connector provided at one end of a lanyard extending from a worker's safety harness to the anchor clamp.

20. The method as defined in claim 19, wherein the step of engaging the anchor clamp to the rafter further comprises:
positioning a first slot defined in a lower end of the first side wall of the anchor clamp a distance below a lower surface of the rafter;
positioning a second slot defined in a lower end of the second side wall of the anchor clamp a same distance below the lower surface of the rafter;
at least partially aligning the first slot with the second slot;
extending a fastener through the at least partially aligned first slot and second slot; and
securing the fastener to the first and second side walls of the anchor clamp.

21. The method as defined in claim 20, wherein the step of engaging the connector comprises:
moving the anchor clamp outwardly relative to the upper surface of the rafter;
separating the middle wall of the anchor clamp from the upper surface of the rafter;
inserting the connector through a hole defined in the anchor clamp's middle wall; and
moving the anchor clamp downwardly so that the middle wall is positioned adjacent the upper surface of the rafter.

22. The method as defined in claim 19, further comprising:
locating an anchor clamp cover provided on a roof;
disengaging the cover from the roof;
exposing a hole beneath the cover;
locating, through the hole, the anchor clamp mounted on the roof rafter; and
inserting the connector through the hole in the roof prior to engaging the connector with the anchor clamp.

23. The method as defined in claim 19, wherein the middle wall comprises a protector plate separate from the first side wall and the second side wall; said method further comprising:
passing a shaft of a second fastener through a bore defined by the protector plate and through aligned holes in the first and second side walls of the anchor clamp.
